(19) United States
(12) Patent Application Publication
(10) Pub. No.: US 2013/0218967 A1
(43) Pub. Date: Aug. 22, 2013

(54) SYSTEM FOR SUGGESTING ACTIVITIES BASED ON CONTACTS

(71) Applicants: Stephen Chau, Palo Alto, CA (US); Andrew Timothy Szybalski, San Francisco, CA (US); Andrea Lynn Frome, Oakland, CA (US); Derek King Prothro, San Mateo, CA (US); Stephane Lafon, Sunnyvale, CA (US)

(72) Inventors: Stephen Chau, Palo Alto, CA (US); Andrew Timothy Szybalski, San Francisco, CA (US); Andrea Lynn Frome, Oakland, CA (US); Derek King Prothro, San Mateo, CA (US); Stephane Lafon, Sunnyvale, CA (US)

(21) Appl. No.: 13/657,752

(22) Filed: Oct. 22, 2012

Related U.S. Application Data
(60) Provisional application No. 61/601,535, filed on Feb. 21, 2012.

(51) Int. Cl. G06F 15/16

(52) U.S. Cl. 709/204

(57) ABSTRACT

The subject technology suggests one or more activities based on one or more contacts of a user. In some configurations, a user selects one or more contacts. The subject technology then performs a query determining one or more activities based on the selected contacts that at least a subset of the users have indicated a desire to do a respective activity. For instance, each of the determined activities include a parameter indicating such a desire (e.g., a “want to do” parameter). The activities determined from the query are ranked based on one or more different criteria. In one example, the activities are ranked according to a number of selected contacts associated with a corresponding activity. Additionally, a group message can be provided for each selected contact associated with a respective activity in order to facilitate communication between the user and contacts.

### CROSS-REFERENCE TO RELATED APPLICATIONS

The present application claims the benefit of priority under 35 U.S.C. §119 from U.S. Provisional Patent Application Ser. No. 61/601,535 entitled “SYSTEM FOR SUGGESTING ACTIVITIES BASED ON CONTACTS,” filed on Feb. 21, 2012, the disclosure of which is hereby incorporated by reference in its entirety for all purposes.

### BACKGROUND

Online social networking services can be used as tools for building and maintaining networks of personal, familial, academic, professional, and other interpersonal relationships. Collectively, a user's network of relationships can be referred to as the user's social graph. In some social networking services, one or more suggestions for potential new contacts can be provided to the user to expand the user's social graph.

### SUMMARY

The subject technology provides a machine-implemented method for suggesting one or more activities based on one or more contacts of a user. The subject technology receives a selection of one or more contacts in which each contact is respectively associated with one or more activities. The subject technology determines one or more activities based on the selected one or more contacts and at least one parameter associated with the determined one or more activities. Each of the determined one or more activities includes a parameter indicating a desire to perform each of the determined one or more activities by one or more selected contacts. The subject technology ranks the determined one or more activities based at least on a number of selected contacts associated with each of the determined one or more activities. Further, the subject technology provides for display the ranked one or more activities and each selected contact associated with the ranked one or more activities.

In some configurations, the selected one or more contacts are social networking contacts of the user. The selection of one or more contacts is based on user input. Each activity includes data indicating a specific deed or action that is desired to be performed by a corresponding contact. The subject technology further ranks the determined one or more activities based one or more signals associated with each of the determined one or more activities. The one or more signals include a level of difficulty associated with each of the ranked one or more activities, one or more interests of the selected contacts, each respective proximity of the selected contacts to the user or location of a respective activity, or a time or date of a respective activity.

The subject technology further provides for receiving a selection of one activity among the ranked one or more activities; generating a group message between each contact associated with the selected one activity; and providing for display the group message between each contact associated with the selected one activity. In some configurations, the group message is one of an instant message, social network post, video conference, e-mail, SMS, and MMS.

The subject technology further receives an input indicating that the user adds an activity among the ranked one or more activities via interaction with a first user interface element; and storing data in a user account associated with the user to indicate that the user has added the activity. The subject technology stores data in a centralized data store indicating that the user has added the activity. The subject technology receives an input indicating that the user has completed one activity among the ranked one or more activities via interaction with a second user interface element; and stores data in the user account associated with the user to indicate that the user has completed the one activity. Additionally, the subject technology stores data in a centralized data store indicating that the user has completed the one activity.

Yet another aspect of the subject technology provides a system for suggesting one or more activities based on one or more contacts of a user. The system includes memory, one or more processors, and one or more modules stored in memory and configured for execution by the one or more processors. The system includes a contacts module configured to receive a selection of one or more contacts in which the selection of one or more contacts is based on user input. Each contact is respectively associated with one or more activities. The system further includes an activity query module configured to determine one or more activities based on the selected one or more contacts and at least one parameter associated with the determined one or more activities. Each of the determined one or more activities includes a parameter indicating a selected contact's desire to perform each of the determined one or more activities. The system also includes an activity ranking module configured to rank the determined one or more activities based at least on a number of selected contacts associated with each of the determined one or more activities, and rank the determined one or more activities based one or more signals associated with each of the determined one or more activities. Additionally, the system includes a GUI display module configured to provide for display the ranked one or more activities and each selected contact associated with the ranked one or more activities. Further, the system includes an activity processing module configured to receive a selection of one activity among the ranked determined one or more activities, and generate a group message between each contact associated with the selected one activity.

In some configurations, the system further includes an activity processing module configured to receive a selection of one activity among the ranked determined one or more activities, and generate a group message between each contact associated with the selected one activity. The activity processing module is further configured to receive an input indicating that the user adds an activity among the ranked one or more activities via interaction with a first user interface element; and store data in a user account associated with the user to indicate that the user has added the activity. Additionally, the activity processing module is further configured to receive an input indicating that the user has completed one activity among the ranked one or more activities via interaction with a second user interface element; and store data in the user account associated with the user to indicate that the user has completed the one activity.

The subject technology further provides for receiving a selection of one or more contacts in which each contact is respectively associated with one or more activities. One or more activities are determined based on the selected one or more contacts and at least one parameter associated with the determined one or more activities in which each of the determined one or more activities includes a parameter indicating a selected contact's desire to perform each of the determined one or more activities. The subject technology ranks the determined one or more activities based at least on a number of selected contacts associated with each of the determined one or more activities. Further, the ranked one or more activities and each selected contact associated with the ranked one or more activities are provided for display. The subject technology receives a selection of one activity among the ranked determined one or more activities. Additionally, a group message between each contact associated with the selected one activity is then generated.

These and other implementations may provide one or more of the following advantages. For example, activities may be suggested to a user in order to provide personalized recommendations that are relevant to the user and the user's existing contacts based on a set of common or shared activities that all or a subset of a set of contacts have indicated a desire to do. The suggested activities are more likely to be completed by the user and contacts and promote social interactions between the user and contacts.

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1A conceptually illustrates an example process for suggesting one or more activities based on one or more contacts of a user.

FIG. 1B conceptually illustrates an example process for determining one or more common completed activities between a user and one or more contacts.

FIG. 2 conceptually illustrates an example process for providing a group message to one or more contacts associated with a selected activity.

FIG. 3 conceptually illustrates an example process for processing user input for indicating that a user adds an activity among ranked activities.

FIG. 4 conceptually illustrates an example process for processing user input for indicating that a user has completed an activity among ranked activities.

FIG. 5 conceptually illustrates an example graphical user interface (GUI) of some configurations of the subject technology.

FIG. 6 conceptually illustrates an example computing environment.

FIG. 7 conceptually illustrates an example architecture of a mobile device.

FIG. 8 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, structures and components are shown in block diagram form in order to avoid obscuring the concepts of the subject technology.

An “activity”, as used herein, can be a data construct describing a thing to do, which a user can associate with a user's “activity-assistant account.” In an example embodiment, an activity is defined at least in part by one or more singular, global activity parameters. For example, global parameters for a given activity may include a title or text description (e.g., “get brunch at Restaurant ABC”), data indicating the location that is associated with the activity (e.g., a latitude/longitude and/or a street address of Restaurant ABC), data indicating one or more user “moods” that may be indicative of the activity being more or less well-suited for a given user at a given point in time (e.g., “fun”, “social”, “cerebral”, “productive”, “ambitious”, etc.), data indicating time constraints on the activity (e.g., the hours that Restaurant ABC is open and/or the hours during which Restaurant ABC serves brunch), and any other data that may be directly or indirectly interpreted to affect the importance of a given activity to a given user.

Generally, an activity is a user-defined construct, and thus the global parameters that define each activity may vary. In particular, a given activity may include all of the above-mentioned global activity parameters, a subset of the above-mentioned parameters, or none of the above-mentioned parameters. For example, a user may create an activity that is not tied to any particular location (e.g., “do homework for art history class”), and thus choose not to provide a location. Furthermore, as activities are flexible and dynamic constructs, it should be understood that the above-mentioned examples of global parameters are not limiting. It is also possible that an activity may be generated by a computing system or device without any initial user input (or alternatively, generated based on some user-provided input).

Once an activity is created, its global parameters may be applied to all users who add the activity or become associated with the activity. Thus, in effect, there is a single copy of each activity and its global parameters that is common to all those users. It should be understood that global parameters are flexible and dynamic, and may change over time in relation to the activity. For example, a “popularity” parameter may be defined for an activity that is updated on an ongoing basis to reflect the number of users that have added the activity.

To further allow for customization of activities to a particular user, “user-specific” parameters, which vary between users, may be defined for an activity. Accordingly, while the global parameters of an activity are the same for all users, each user that adds an activity may customize their user-specific parameters for the activity. For instance, user-specific parameters may be used to specify (a) plans regarding the activity (e.g., “I want to do it”, “I want to do it again, but not for a few weeks,” “I must do it before July 4,” “I never want to do it again,” etc.), (b) the user's history regarding that activity (e.g., I went there with Lauren on November 4 and again with Ryan on November 28), (c) personal time constraints based on user preferences (e.g., preference of brunch early on Sunday so that time is available to digest before yoga class at noon), and/or (d) any other personal preferences that may overrides or modify the global parameters (e.g., “I like to go to Restaurant ABC when I'm sad because it cheers me up,” “I like to go to Restaurant ABC when I have friends in town,” etc.). Further, an activity can be designated as a “public” or “private” activity. Depending on how a given activity is defined, this designation may be made by setting a global parameter when the activity is created (and thus apply to all users who add the activity), and/or may be made via a user-specific parameter that is settable by each user who adds an activity.

In an example implementation, an “activity assistant system” is provided, which is configured to evaluate the relative importance of activities to a particular user so that activities can be presented on the user interface of the activity assistant system in a logical manner. In particular, the activity assistant system may score an activity based not only on the characteristics of the activity itself, but also based on data that is indicative of the user's “context” (e.g., the user's, interests, intents, moods, experiences, associations with other users, etc.). With the support of the activity assistant system, the user interface of the activity assistant system may therefore provide users with a dynamic and flexible mechanism for deciding what activities they might enjoy, and how they would like to spend their time.

In order to quantify the importance of a particular activity for a particular user, the activity assistant system identifies and/or determines any number of “signals” that is directly or indirectly relevant to the importance of an activity to the particular user. From the perspective of the activity assistant system, signals can take the form of information provided by global parameters and user-specific parameters taken individually or information determined by evaluating interactions between global parameters, user-specific parameters, and/or other data sources. The activity assistant system evaluates the signals for a particular combination of user and activity, and based on the signals, quantify the importance of the particular activity for the particular user (e.g., by assigning a “score” to the activity).

To provide some examples of such signals, they include but are not limited to: an indication of a user's desire to do or complete an activity (e.g., plans), the level of similarity between user's mood and activity mood, the level of similarity between the user's context (as indicated by user-specific signals and/or user-specific parameters indicating, for example, whether the user is on a desktop computer/mobile phone, on-line/off-line, talking on the phone, driving, walking, etc.) and corresponding activity context requirements and/or restrictions (as indicated by global parameters of the activity), a distance between the user's current detected (or indicated) location and the activity location (if available), the appropriateness of the activity for the current weather conditions at the user's current or indicated location and/or the current weather conditions at the activity's indicated location (e.g., rainy, sunny, snowy, etc.), a user-designated priority for the activity, a user-designated due date (or next due date, if recurring), a user's snooze history or pattern for the activity, an amount of time required for the activity, a progress or status of the activity (done, active, in-progress, etc.), ownership of the activity (e.g., whether the owner is the particular user in question or another user), whether the user received an invitation to the activity or just a notice that the activity exists (e.g., a “heads-up”), a popularity of the activity (e.g., number of comments on an activity, or the number of people who have commented, copied, liked, shared, done, or followed the activity), a similarity between a user query string and the activity text (for search/suggest), a similarity between a user query string and the names or e-mails of other users associated with the activity (for search/suggest), a similarity between user query string and activity comment text (for search/suggest), and whether the user indicated another user with whom to participate in the activity with. Other types of signals can be included and still be within the scope of the subject technology.

Supported with this intelligence from the activity assistant system, the user interface of the activity assistant system presents activities that a particular user has associated with their account in a logical order that is based at least in part upon the relative importance of the activities to the user. In particular, the activity assistant system evaluates the signals for each activity in a user's activity list (i.e., each activity that has been added by the user) and assign a score to the activity. The activity assistant system can then rank the activities in the user's activity list according to their respectively determined score, and relay this information to the user interface of the activity assistant system so that it can adjust the displayed activity list accordingly.

Further, the intelligence of the activity assistant system is utilized to provide “suggested” activities that are tailored to the particular user's preferences, tendencies, location, time table, associated other users, and/or mood at a given point in time. In particular, the activity assistant system initiates an activity search that takes into account the scores of activities when ranking the search results, and these search results are presented to the user via the user interface of the activity assistant system. In a similar manner, the activity assistant system supports an “activity search” feature of the user interface of the activity assistant system. This feature allows the user to enter text and initiate an activity search on the text, the results of which factor in the relative scores of activities as assessed by the activity assistant system.

According to an example implementation, a user interface is provided that allows for intuitive user interaction with such activities. A user typically accesses the user interface of the activity assistant system by logging in to a user's account in the activity-assistant system. According to an example implementation, the user interface of the activity assistant system displays graphical representations of activities to a user in a logical manner that varies according to the interests, intents, associations with other users, and moods of the user. Via the user interface of the activity assistant system, the user views activities they have added to a personal “activity list,” view suggested activities, create and add new activities to their activity list, and/or add/delete existing activities (e.g., those created by other users) to/from their activity list, among other functions.

In some embodiments, the user interface provides a visualization of (a) how the user has been spending his or her time; and (b) how the user could be spending his or hers time in the future.

However, a given online social networking service typically does not provide personalized recommendations for activities that are relevant to the user and the user's existing contacts. The follow description describes example implementations for providing suggested activities based on a user's contacts.

As described further herein, the user interface of the activity assistant system provides an interface for providing one or more suggested activities based on one or more selected contacts. In one example, the activity assistant system provides a display of one or more contacts (e.g., contacts that a user may have some interest in, such as people the user follows and people who follow the user on social networks, people that may be similar to the user based on interests, etc.). The user selects one or more of the contacts (or alternatively, searches for contacts). Based on the selected contacts, the activity assistant system determines a set of common or shared activities that all of the selected contacts have indicated a desire or want to do. Further, the activity assistant system also determines activities that a subset of the selected contacts have indicated a desire or want to do. In this manner, the activity assistant system provides one or more suggested activities to the user. The activity assistant system also enables the user to initiate a group message with the selected contacts associated with a respective activity that the system has suggested.

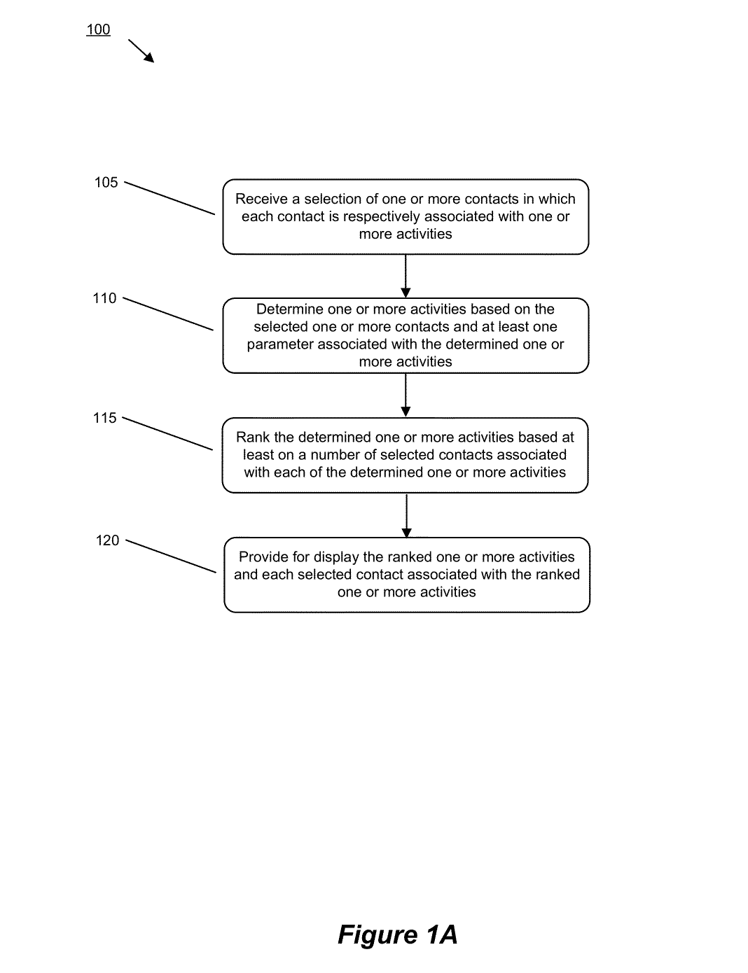

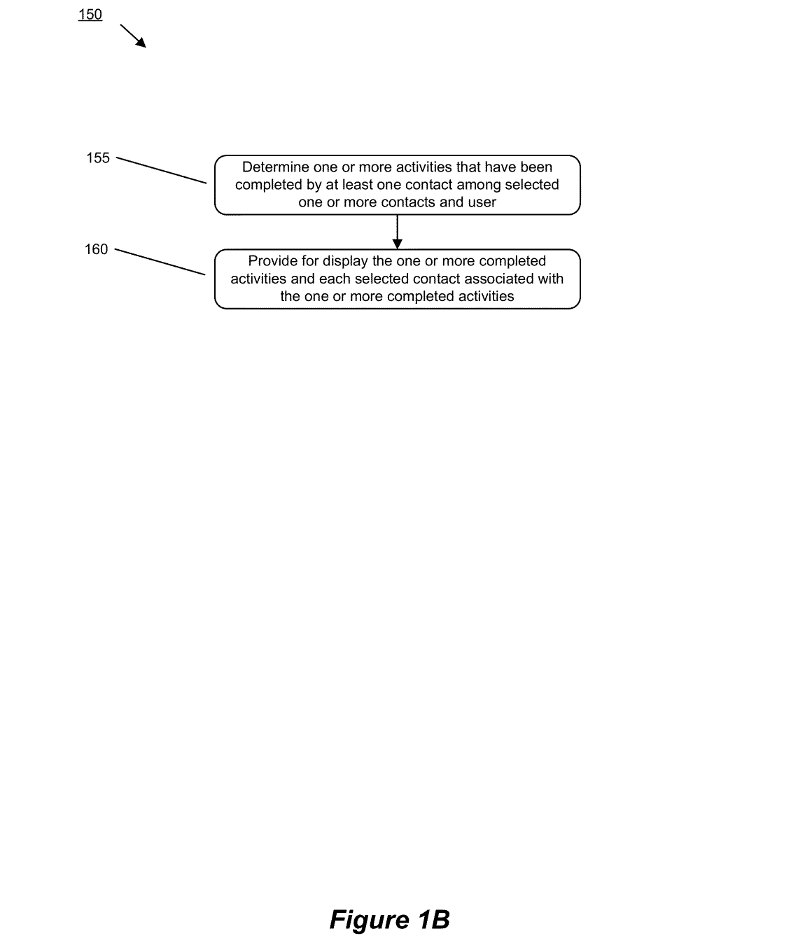

FIG. 1A conceptually illustrates an example process 100 for suggesting one or more activities based on one or more contacts of a user. The process 100 is performed by one or more computing devices or systems in some configurations.

The process 100 begins at 105 by receiving a selection of one or more contacts, wherein each contact is respectively associated with one or more activities. In one example, the selected one or more contacts are social networking contacts of the user. Other types of contacts can be included are still be within the scope of the subject technology. For instance, contacts from e-mail, text messaging and/or instant messaging are selected in one example. The selection of one or more contacts is based on user input. In one example, the selection of the one or more contacts can include user input such as, but not limited to, a mouse cursor selection, a keyboard shortcut selection, a touch input selection (e.g., via a touchscreen device), etc. Other types of user input can be received for selecting the contacts and still be within the scope of the subject technology. Although the above example describes a selection of one or more contacts, alternatively, the user searches for any other user of the activity assistant system in order to select different users.

The process 100 at 110 determines one or more activities based on the selected one or more contacts and at least one parameter associated with the determined one or more activities. For instance, each of the determined one or more activities includes a parameter indicating a desire to perform the determined activities by the selected contacts (e.g., a “want-to-do” parameter). In one example, each activity includes data indicating a specific deed or action that is desired to be performed by a corresponding contact (e.g., “see the northern lights,” “visit the pyramids,” “go see a movie,” “try new restaurant in downtown,” “make beer at home,” “start a company,” etc.). By way of example, the process 100 performs a search query on one or activities (e.g., from a data store including activity data) associated with each selected contact to determine each activity that at least one selected contact has indicated a desire to perform based on the parameter (e.g., the “want-to-do” parameter).

The process 100 at 115 ranks the determined one or more activities based at least on a number of selected contacts associated with each of the determined one or more activities. For instance, the activities are ranked so any activity in which that all of the selected contacts indicate a desire to do are ranked higher than any other activity that only a subset of the selected contacts indicate a desire to do. In some configurations, the process 100 further ranks the determined one or more activities based on one or more signals associated with each of the determined one or more activities. Some examples of signals include, but not limited to, a level of difficulty associated with each of the ranked one or more activities, one or more interests of the selected contacts, each respective proximity of the selected contacts to the user or location of a respective activity, a time or date of a respective activity, etc. Other signals can be utilized and still be within the scope of the subject technology. By ranking the activities, the process 100 can sort the determined activities according to a relevancy metric.

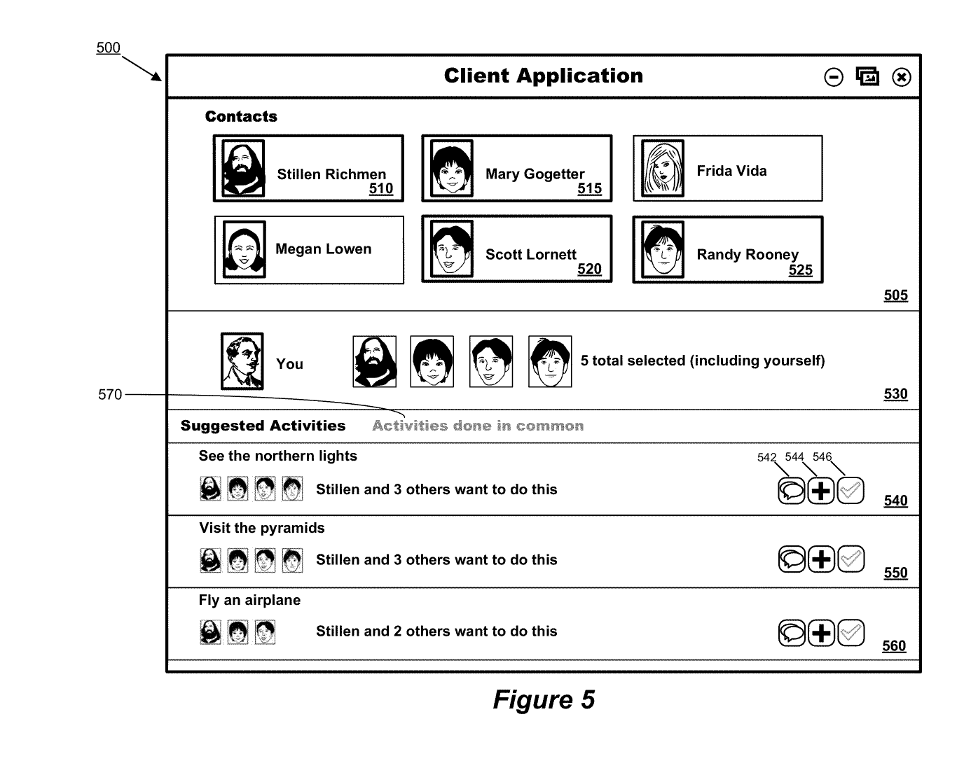

The process 100 at 120 provides for display the ranked one or more activities and each selected contact associated with the ranked one or more activities. An example graphical user interface (GUI) that displays the ranked activities is described in further detail in FIG. 5. The process 100 then ends.

FIG. 1B conceptually illustrates an example process 150 for determining one or more common completed activities between a user and one or more contacts. The process 100 is performed by one or more computing devices or systems in some configurations. In one example, the process 150 is performed conjunctively with the process 100 described in FIG. 1A. For instance, based on the selected contacts at 105 in the process 100, the process 150 determines one or more common activities that have been completed by the user and at least one selected contact.

The process 150 begins at 155 by determining one or more activities that have been completed by at least one contact among the selected one or more contacts and the user. Referring to FIG. 1A, the selected contacts can be provided by user input selecting one or more contacts or provided via a search query for contacts. In one example, each activity includes a parameter indicating whether the activity has been completed (e.g., parameter indicating a progress or status of the activity as being “done” or “completed”). The process 150 performs a search query on one or activities (e.g., from a data store including activity data) associated with each selected contact. The process 150 then determines whether the user and at least one selected contact(s) has completed the activity as indicated by the parameter.

The process 150 at 160 then provides for display the one or more completed activities and each selected contact associated with the one or more completed activities. The process 150 then ends. In this manner, the process 150 provides one or more activities that the user and the selected contacts have both completed, which enables the user to review former activities that have been commonly done by the user and any selected contact(s).

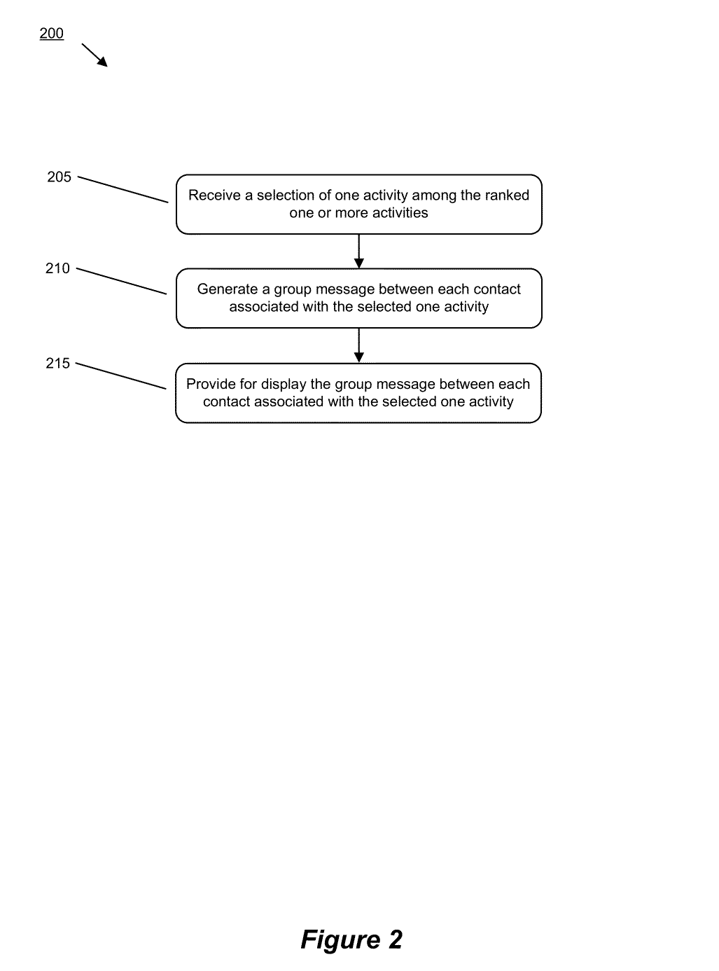

FIG. 2 conceptually illustrates an example process 200 for providing a group message to one or more contacts associated with a selected activity. The process 200 can be performed by one or more computing devices or systems in some configurations. In one example, the process 200 can be performed conjunctively with the process 100 described in FIG. 1A.

The process 200 begins at 205 by receiving a selection of one activity among the ranked one or more activities. The process 200 at 210 generates a group message between each contact associated with the selected one activity. In some configurations, the group message is one of an instant message, social network post, video conference, e-mail, SMS, and MMS. The process 200 at 215 provides for display the group message between each contact associated with the selected one activity. The process 200 then ends.

The group message provided by the process 200 facilitates communication between a user and any selected contacts associated with a respective activity. In this manner, the user can plan with or communicate with the selected users in order to complete a respective activity provided by the process 100 in FIG. 1A.

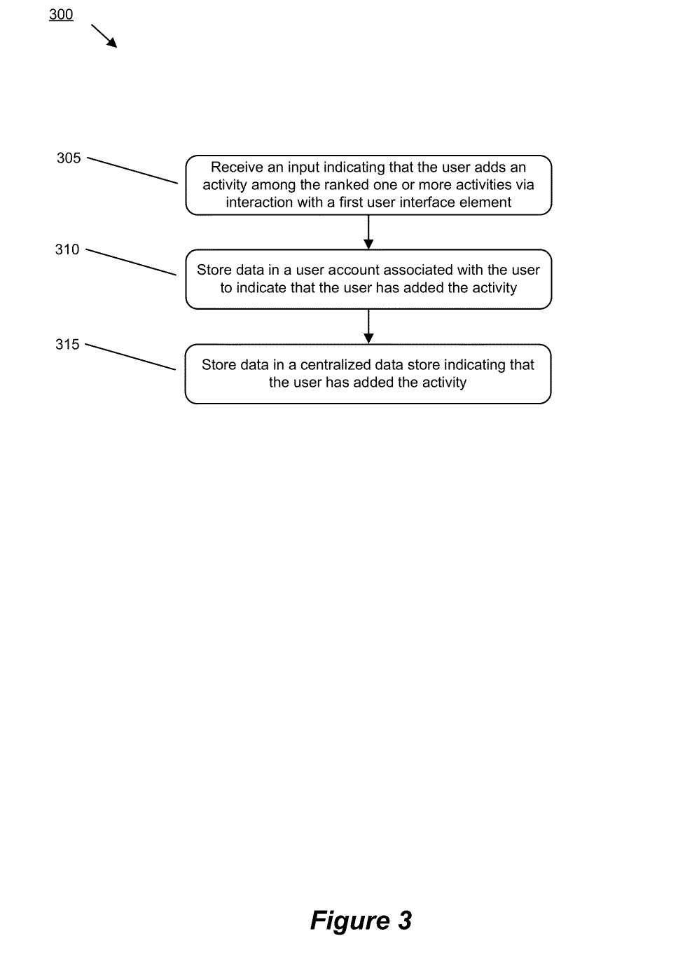

FIG. 3 conceptually illustrates an example process 300 for processing user input for indicating that a user adds an activity among ranked activities. The process 300 can be performed by one or more computing devices or systems in some configurations. In one example, the process 300 can be performed conjunctively with the process 100 described in FIG. 1A.

The process 300 begins at 305 receiving an input indicating that the user adds an activity among the ranked one or more activities via interaction with a first user interface element. The process 300 at 310 stores data in a user account (e.g., in a user-account data store) associated with the user to indicate that the user has added the activity. The process 300 at 315 stores data in a centralized data store (e.g., global activity data store) indicating that the user has added the activity. The process 300 then ends.

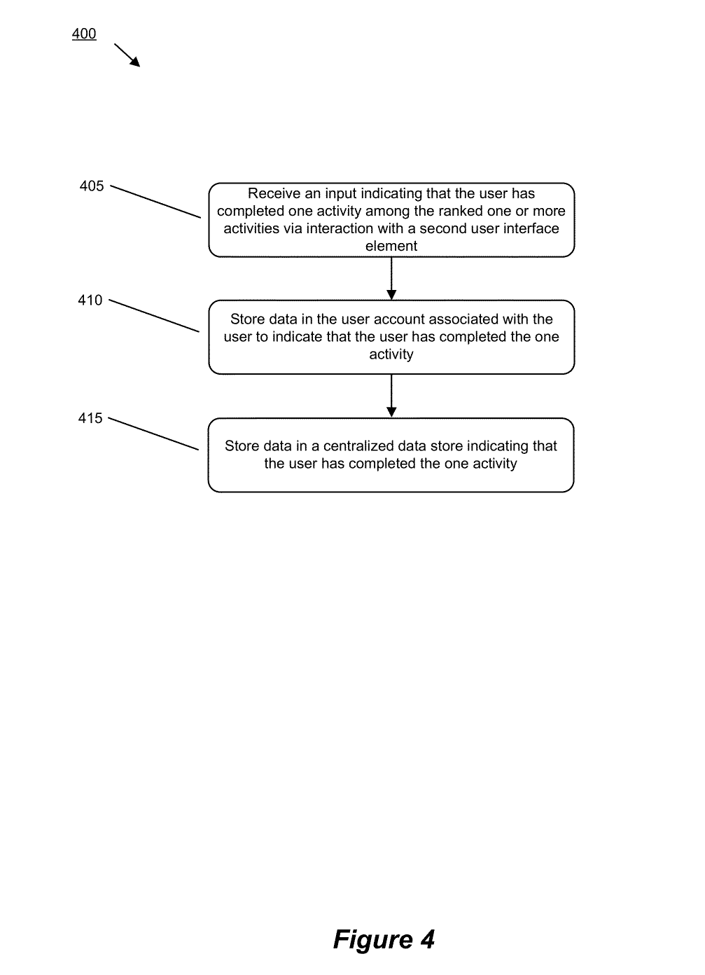

FIG. 4 conceptually illustrates an example process 400 for processing user input for indicating that a user has completed an activity among ranked activities. The process 400 can be performed by one or more computing devices or systems in some configurations. In one example, the process 400 can be performed conjunctively with the process 100 described in FIG. 1A.

The process 400 begins at 405 by receiving an input indicating that the user has completed one activity among the ranked one or more activities via interaction with a second user interface element. The process 400 at 410 stores data in the user account (e.g., in a user-account data store) associated with the user to indicate that the user has completed the one activity. The process 400 at 415 stores data in a centralized data store (e.g., global activity data store) indicating that the user has completed the one activity. The process 400 then ends.

FIG. 5 conceptually illustrates a graphical user interface (GUI) 500 in which some configurations of the subject technology can be implemented. More specifically, the GUI 500 can include different sets of graphical elements for providing and interacting with one or more suggested activities as described in FIGS. 1-4. A graphical element can include, but is not limited to, a button, check box, radio button, slider, list box, drop-down list, menu, combo box, icon, text box, scroll bar, etc. In one example, the GUI 500 is displayed in a client application such as a web browser, mobile application, or desktop application. The GUI 500 is provided by an online service or system in some configurations. Additionally, in some configurations, the GUI 500 is provided in a widget. As used herein, the term “widget” refers to a lightweight application (e.g., lightweight in comparison to a full application suite or software package) providing a GUI that includes one or more graphical elements used to provide a specific application.

As illustrated in FIG. 5, the GUI 500 includes display areas 505, 530, 540, 550 and 560. In the example GUI 500, the display area 505 include respective graphical representations 510, 515, 520 and 525 (e.g., an avatar, profile image, icon, etc.) corresponding to different selected users (e.g., contacts). In one example, the different users illustrated in the example GUI 500 are contacts that a user is following (e.g., the user has added) and contacts that are following the user (e.g., the contacts have added the user). The selected users shown in the display area 505 are selected responsive to user input (e.g., touch selection input on a touch screen device as shown, mouse cursor input, keyboard input, etc.). As further shown, other users in the display area 505 that are not selected (shown as non-highlighted). In one example, the users are members of an online social networking service or other service that provides the herein described activity assistant system. Additionally, the GUI 500 includes the display area 530 that provides information indicating a number of users that have been selected.

In some configurations, the users shown in the display area 505 are not limited to people that are direct contacts (e.g., contacts that a user has explicitly added). For instance, the display area 505 can include various contacts based on other criteria. By way of example, the display area 505 includes one or more contacts with similar interests to a user. In this manner, the GUI 500 provided by the activity assistant system can display suggested other contacts to the user based on shared interests and/or other criteria.

Each of the display areas 540, 550 and 560 includes a respective suggested activity that includes at least a subset of the selected users from the display area 505 (e.g., as determined by the process 100 in FIG. 1A). As shown in the example GUI 500, the activities are displayed in vertical descending order (e.g., from top to bottom) based on at least a number of users that have indicated (e.g., based on a parameter associated with an activity) a desire to do the respective activity. Other ways to display the suggested activities can be provided and still be within the scope of the subject technology. For instance, one or more activities can be shown in the GUI 500 based one or more different signals. By way of example, the activities shown in the GUI 500 are displayed, for instance, according to a level of difficulty, a proximity to a user, a location and/or time/date. Other types of signals can be utilized for sorting the activities for display in the GUI 500 and still be within the scope of the subject technology.

As further shown in the display area 540, 550 and 560, a corresponding set of buttons are provided to activate different functionality. Referring to the display area 540, buttons 542, 544 and 546 are illustrated. In one example, the button 545 if selected (e.g., via user input) generates a group message between each of the users for the activity shown in the display area 540. The button 544 if selected (e.g., via user input) allows the user to add the activity shown in the display area 540. The button 546 if selected allows the user to indicate that the user has completed the activity shown in the display area 540. Other buttons can be provided in each of the display 540, 550 and 560 and still be within the scope of the subject technology.

The GUI 500 also illustrates an option or menu item 570 that toggles a display for one or more activities that have been completed by the user and the selected contacts (e.g., as determined by the process 150 in FIG. 1B). Upon selection of the option 570, the GUI 500 provides for display any commonly completed activities between the user and at least one selected contact(s). In one example, the GUI 500 can display the commonly completed activities in a manner similar to the suggest activities shown in the display areas 540, 550 and 560 described above.

Although the example GUI 500 in FIG. 5 includes three different activities, any number of activities can be included in the GUI 500 and still be within the scope of the subject technology.

Additionally, although the above description of FIG. 5 includes different example graphical elements in the GUI 500, some implementations can include other graphical elements in the GUI 500 and still be within the scope of the subject technology. Further, the GUI 500 is not required to include all of the aforementioned graphical elements.

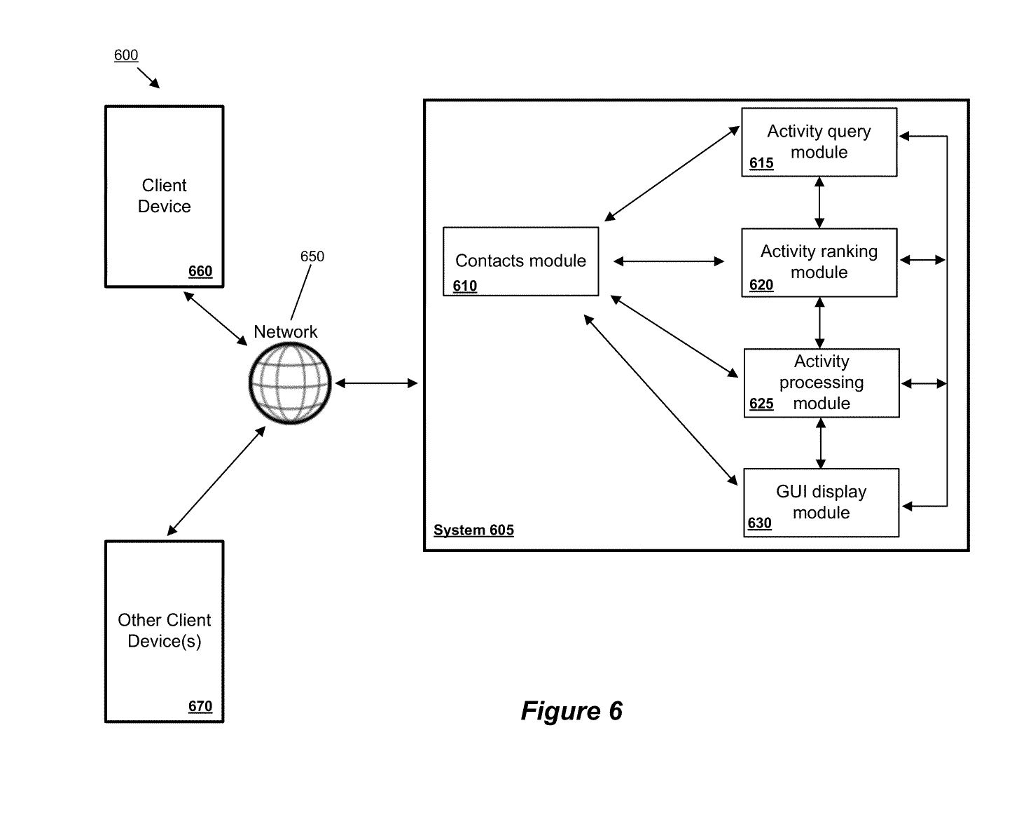

FIG. 6 conceptually illustrates an example computing environment 600 including a system. In particular, FIG. 6 shows a system 605 for implementing the above described processes in FIGS. 1-4 and for providing the GUI illustrated in FIG. 5. In some configurations, the system 605 is part of an implementation running a particular machine (e.g., a server).

The system 605 can include memory, one or more processors, and one or more modules stored in memory and configured for execution by the one or more processors. As shown in FIG. 6, the system 605 includes several modules for providing different functionality. The system 605 is configured to include a contacts module 610, activity query module 615, activity ranking module 620, activity processing module 625, and a GUI display module 630. The contacts module 610 is configured to receive a selection of one or more contacts in which the selection of one or more contacts is based on user input. In one example, each contact is respectively associated with one or more activities. The activity query module 615 is configured to determine one or more activities based on the selected one or more contacts and at least one parameter associated with the determined one or more activities. In some configurations, each of the determined one or more activities includes a parameter indicating a selected contact's desire to perform each of the determined one or more activities. The activity ranking module 620 is configured to rank the determined one or more activities based at least on a number of selected contacts associated with each of the determined one or more activities, and rank the determined one or more activities based one or more signals associated with each of the determined one or more activities. The activity processing module 625 is configured to receive a selection of one activity among the ranked determined one or more activities, and generate a group message between each contact associated with the selected one activity Additionally, the GUI display module 630 is configured to provide for display the ranked one or more activities and each selected contact associated with the ranked one or more activities.

In some configurations, the activity processing module 625 is further is configured to receive an input indicating that the user adds an activity among the ranked one or more activities via interaction with a first user interface element, and store data in a user account associated with the user to indicate that the user has added the activity. Further, the activity processing module 625 is further is configured to receive an input indicating that the user has completed one activity among the ranked one or more activities via interaction with a second user interface element, and store data in the user account associated with the user to indicate that the user has completed the one activity.

As further shown in FIG. 6, each of the aforementioned modules can be configured to communicate between each other. For instance, different data, messages, API calls and returns can be passed between the different modules in the system 605.

The system 605 can communicate over a network 650 with a client device 660. The client device 660 can each be configured to communicate with the aforementioned modules of the system 605. For instance, the client device 660 can transmit a request for determining one or more activities based one or more selected contacts and/or a request for generating a group message between a user and one or more contacts associated with an activity over the network 650 to the system 605. The system 605 can then transmit data responsive to any of the aforementioned requests over the network 650 to the client device 660. As further shown in FIG. 6, other client device(s) 670 can communicate over the network 650 with the system 605 in a similar manner.

In one example, the system 605 accesses a global activity data store that includes activity data that defines a plurality of activities. In particular, the activity data for each activity may include one or more global activity parameters that collectively define the global context for the activity. Further, the system 605 includes a user-account data store that includes per-account data for users' activity accounts. This per-account data may include, for a given one of the accounts, data indicating user-specific parameters and signals. Further, for a given activity account, the per-account data may include an indication of which activities, if any, are associated with the account (e.g., the activities that a user has added to their activity list). In one example, the aforementioned global activity data store and/or the user-account data store are centralized data stores. Moreover, the system 605 can access the activity data store and/or the user-account data store over a network or locally depending on the respective location of each of the data stores.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

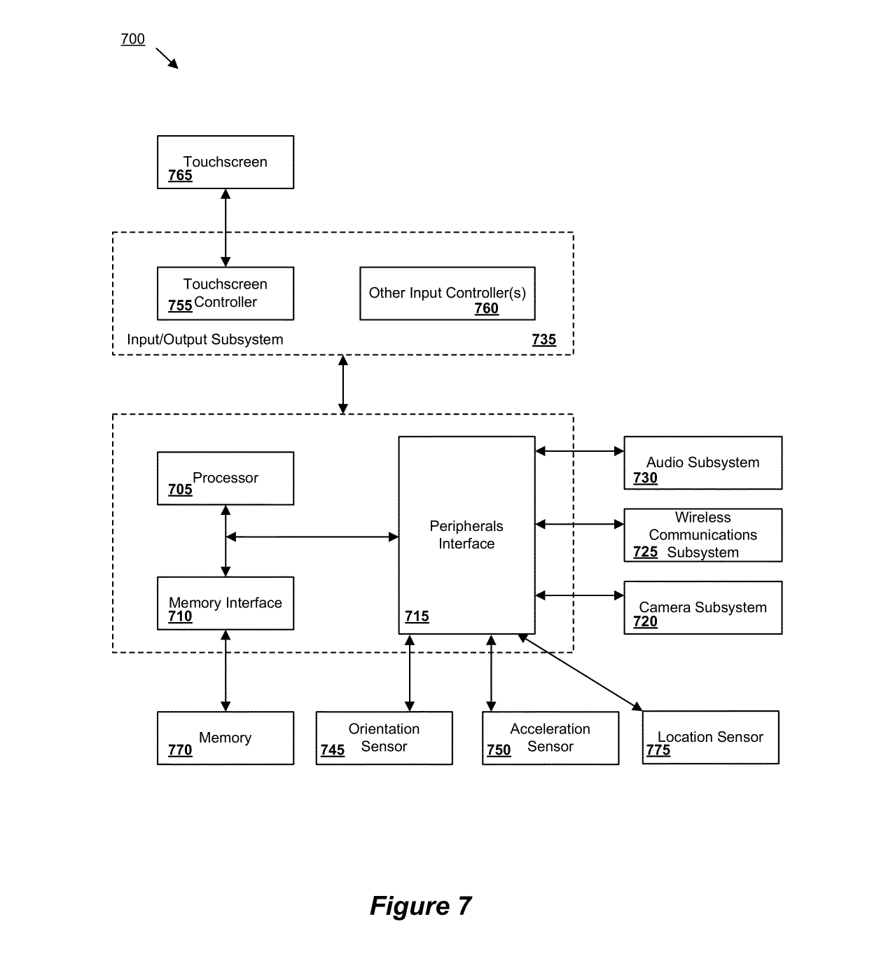

FIG. 7 is an example of a mobile device architecture 700. In some configurations, aspects of the subject technology can be implemented and performed on such a mobile device architecture. The implementation of a mobile device can include one or more processing units 705, memory interface 710 and a peripherals interface 715. Each of these components that make up the computing device architecture can be separate components or integrated in one or more integrated circuits. These various components can also be coupled together by one or more communication buses or signal lines.

The peripherals interface 715 can be coupled to various sensors and subsystems, including a camera subsystem 720, a wireless communication subsystem(s) 725, audio subsystem 730 and Input/Output subsystem 735. The peripherals interface 715 enables communication between processors and peripherals. The peripherals provide different functionality for the mobile device. Peripherals such as an orientation sensor 745 or an acceleration sensor 750 can be coupled to the peripherals interface 715 to facilitate the orientation and acceleration functions. Additionally, the mobile device can include a location sensor 775 to provide different location data. In particular, the location sensor can utilize a Global Positioning System (GPS) to provide different location data such as longitude, latitude and altitude.

The camera subsystem 720 can be coupled to one or more optical sensors such as a charged coupled device (CCD) optical sensor or a complementary metal-oxide-semiconductor (CMOS) optical sensor. The camera subsystem 720 coupled with the sensors can facilitate camera functions, such as image and/or video data capturing. Wireless communication subsystems 725 can serve to facilitate communication functions. Wireless communication subsystems 725 can include radio frequency receivers and transmitters, and optical receivers and transmitters. The aforementioned receivers and transmitters can be implemented to operate over one or more communication networks such as a Long Term Evolution (LTE), Global System for Mobile Communications (GSM) network, a Wi-Fi network, Bluetooth network, etc. The audio subsystem 730 is coupled to a speaker and a microphone to facilitate voice-enabled functions, such as voice recognition, digital recording, etc.

I/O subsystem 735 involves the transfer between input/output peripheral devices, such as a display, a touchscreen, etc., and the data bus of the processor 705 through the Peripherals Interface. I/O subsystem 735 can include a touchscreen controller 755 and other input controllers 70 to facilitate these functions. Touchscreen controller 755 can be coupled to the touchscreen 75 and detect contact and movement on the screen using any of multiple touch sensitivity technologies. Other input controllers 70 can be coupled to other input/control devices, such as one or more buttons.

Memory interface 710 can be coupled to memory 770, which can include high-speed random access memory and/or non-volatile memory such as flash memory. Memory 770 can store an operating system (OS). The OS can include instructions for handling basic system services and for performing hardware dependent tasks.

By way of example, memory can also include communication instructions to facilitate communicating with one or more additional devices, graphical user interface instructions to facilitate graphic user interface processing, image/video processing instructions to facilitate image/video-related processing and functions, phone instructions to facilitate phone-related processes and functions, media exchange and processing instructions to facilitate media communication and processing-related processes and functions, camera instructions to facilitate camera-related processes and functions, and video conferencing instructions to facilitate video conferencing processes and functions. The above identified instructions need not be implemented as separate software programs or modules. Various functions of mobile device can be implemented in hardware and/or in software, including in one or more signal processing and/or application specific integrated circuits.

The following description describes an example system in which aspects of the subject technology can be implemented.

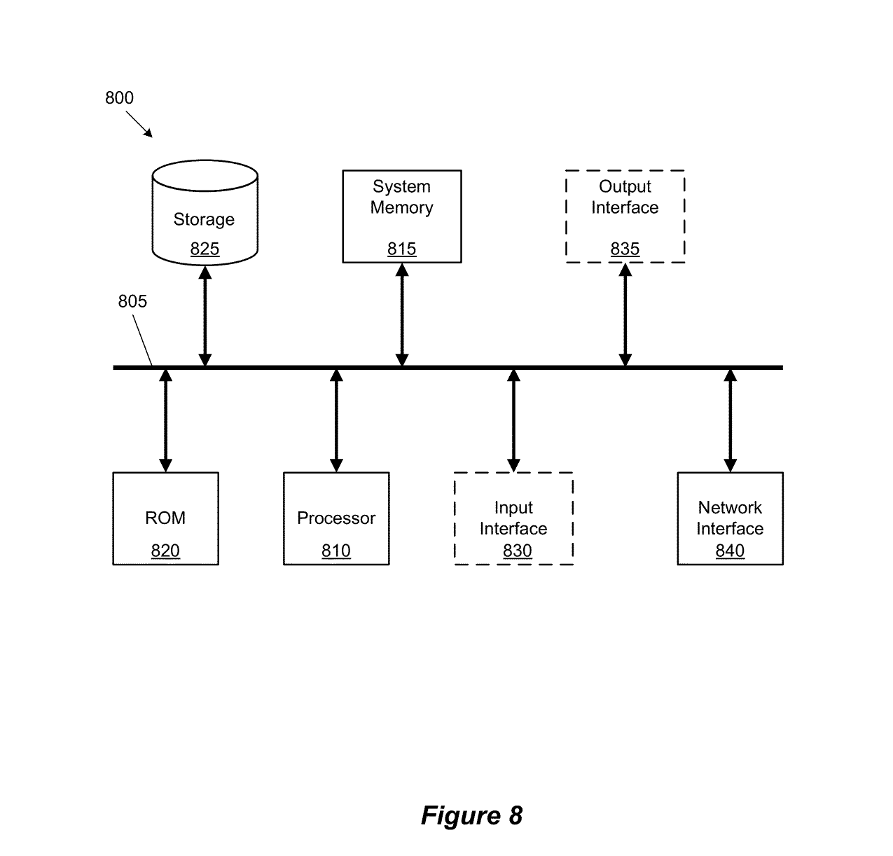

FIG. 8 conceptually illustrates a system 800 with which some implementations of the subject technology can be implemented. The system 800 can be a computer, phone, PDA, or any other sort of electronic device. In some configurations, the system 800 includes a television with one or more processors embedded therein. Such a system includes various types of computer readable media and interfaces for various other types of computer readable media. The system 800 includes a bus 805, processing unit(s) 810, a system memory 815, a read-only memory 820, a storage device 825, an optional input interface 830, an optional output interface 835, and a network interface 840.

The bus 805 collectively represents all system, peripheral, and chipset buses that communicatively connect the numerous internal devices of the system 800. For instance, the bus 805 communicatively connects the processing unit(s) 810 with the read-only memory 820, the system memory 815, and the storage device 825.

From these various memory units, the processing unit(s) 810 retrieves instructions to execute and data to process in order to execute the processes of the subject technology. The processing unit(s) can be a single processor or a multi-core processor in different implementations.

The read-only-memory (ROM) 820 stores static data and instructions that are needed by the processing unit(s) 810 and other modules of the system 800. The storage device 825, on the other hand, is a read-and-write memory device. This device is a non-volatile memory unit that stores instructions and data even when the system 800 is off. Some implementations of the subject technology use a mass-storage device (such as a magnetic or optical disk and its corresponding disk drive) as the storage device 825.

Other implementations use a removable storage device (such as a flash drive, a floppy disk, and its corresponding disk drive) as the storage device 825. Like the storage device 825, the system memory 815 is a read-and-write memory device. However, unlike storage device 825, the system memory 815 is a volatile read-and-write memory, such a random access memory. The system memory 815 stores some of the instructions and data that the processor needs at runtime. In some implementations, the subject technology's processes are stored in the system memory 815, the storage device 825, and/or the read-only memory 820. For example, the various memory units include instructions for processing multimedia items in accordance with some implementations. From these various memory units, the processing unit(s) 810 retrieves instructions to execute and data to process in order to execute the processes of some implementations.

The bus 805 also connects to the optional input and output interfaces 830 and 835. The optional input interface 830 enables the user to communicate information and select commands to the system. The optional input interface 830 can interface with alphanumeric keyboards and pointing devices (also called “cursor control devices”). The optional output interface 835 can provide display images generated by the system 800. The optional output interface 835 can interface with printers and display devices, such as cathode ray tubes (CRT) or liquid crystal displays (LCD). Some implementations can interface with devices such as a touchscreen that functions as both input and output devices.

Finally, as shown in FIG. 8, bus 805 also couples system 800 to a network interface 840 through a network adapter (not shown). In this manner, the computer can be a part of a network of computers (such as a local area network (“LAN”), a wide area network (“WAN”), or an Intranet, or an interconnected network of networks, such as the Internet. Any or all components of system 800 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable practice of the various aspects described herein. Various modifications to these aspects will be readily apparent, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure are expressly incorporated herein by reference and are intended to be encompassed by the claims.

What is claimed is:

1. A machine-implemented method, the method comprising:
receiving a selection of one or more contacts, wherein each contact is respectively associated with one or more activities;
determining one or more activities based on the selected one or more contacts and at least one parameter associated with the determined one or more activities, wherein each of the determined one or more activities includes a parameter indicating a desire to perform each of the determined one or more activities by one or more selected contacts;
ranking the determined one or more activities based at least on a number of selected contacts associated with each of the determined one or more activities; and
providing for display the ranked one or more activities and each selected contact associated with the ranked one or more activities.

2. The method of claim 1, wherein the selected one or more contacts are social networking contacts of the user.

3. The method of claim 1, wherein the selection of one or more contacts is based on user input.

4. The method of claim 1, wherein each activity includes data indicating a specific deed or action that is desired to be performed by a corresponding contact.

5. The method of claim 1, further comprising:
ranking the determined one or more activities based one or more signals associated with each of the determined one or more activities.

6. The method of claim 5, wherein the one or more signals include a level of difficulty associated with each of the ranked one or more activities.

7. The method of claim 5, wherein the one or more signals include one or more interests of the selected contacts.

8. The method of claim 5, wherein the one or more signals include each respective proximity of the selected contacts to the user or location of a respective activity.

9. The method of claim 5, wherein the one or more signals include a time or date of a respective activity.

10. The method of claim 1, further comprising:
receiving a selection of one activity among the ranked one or more activities;
generating a group message between each contact associated with the selected one activity; and
providing for display the group message between each contact associated with the selected one activity.

11. The method of claim 10, wherein the group message is one of an instant message, social network post, video conference, e-mail, SMS, and MMS.

12. The method of claim 1, further comprising:
receiving an input indicating that the user adds an activity among the ranked one or more activities via interaction with a first user interface element; and
storing data in a user account associated with the user to indicate that the user has added the activity.

13. The method of claim 12, further comprising:
storing data in a centralized data store indicating that the user has added the activity.

14. The method of claim 12, further comprising:
receiving an input indicating that the user has completed one activity among the ranked one or more activities via interaction with a second user interface element; and
storing data in the user account associated with the user to indicate that the user has completed the one activity.

15. The method of claim 14, further comprising:
storing data in a centralized data store indicating that the user has completed the one activity.

16. A system, the system comprising:
memory;
one or more processors;
one or more modules stored in memory and configured for execution by the one or more processors, the modules comprising:
a contacts module configured to receive a selection of one or more contacts, wherein each contact is respectively associated with one or more activities, wherein the selection of one or more contacts is based on user input;
an activity query module configured to determine one or more activities based on the selected one or more contacts and at least one parameter associated with the determined one or more activities, wherein each of the determined one or more activities includes a parameter indicating a selected contact's desire to perform each of the determined one or more activities;
an activity ranking module configured to rank the determined one or more activities based at least on a number of selected contacts associated with each of the determined one or more activities, and rank the determined one or more activities based one or more signals associated with each of the determined one or more activities; and
a graphical user interface (GUI) display module configured to provide for display the ranked one or more activities and each selected contact associated with the ranked one or more activities.

17. The system of claim 16, further comprising:
an activity processing module configured to receive a selection of one activity among the ranked determined one or more activities, and generate a group message between each contact associated with the selected one activity.

18. The system of claim 17, wherein the activity processing module is further configured to:
receive an input indicating that the user adds an activity among the ranked one or more activities via interaction with a first user interface element; and
store data in a user account associated with the user to indicate that the user has added the activity

19. The system of claim 17, wherein the activity processing module is further configured to:
receive an input indicating that the user has completed one activity among the ranked one or more activities via interaction with a second user interface element; and
store data in the user account associated with the user to indicate that the user has completed the one activity.

20. A machine-readable medium comprising instructions stored therein, which when executed by a machine, cause the machine to perform operations comprising:
receiving a selection of one or more contacts, wherein each contact is respectively associated with one or more activities;
determining one or more activities based on the selected one or more contacts and at least one parameter associated with the determined one or more activities, wherein each of the determined one or more activities includes a parameter indicating a selected contact's desire to perform each of the determined one or more activities;
ranking the determined one or more activities based at least on a number of selected contacts associated with each of the determined one or more activities;
providing for display the ranked one or more activities and each selected contact associated with the ranked one or more activities;
receiving a selection of one activity among the ranked determined one or more activities; and
generating a group message between each contact associated with the selected one activity.
